(19) United States
(12) Patent Application Publication
(10) Pub. No.: US 2026/0179011 A1
(43) Pub. Date: Jun. 25, 2026

(54) SUSTAINABLE DATA-ON-WHEEL TRANSPORTATION SYSTEM

(71) Applicant: INTERNATIONAL BUSINESS MACHINES CORPORATION, Armonk, NY (US)

(72) Inventors: Abhishek Jain, Baraut (IN); Siddhartha Sood, Ghaziabad (IN)

(21) Appl. No.: 19/001,074

(22) Filed: Dec. 24, 2024

(51) Int. Cl. G06Q 10/0631; G06Q 10/0639

(52) U.S. Cl. CPC G06Q 10/06315; G06Q 10/06393

(57) ABSTRACT

A method and system for dynamic placement of vehicles within a geographic region (e.g., a city) are described herein. Metadata of a plurality of vehicles in a geographic region is read. Data cache demand and a sustainability metric for at least one subregion of the geographic region is read. Based on the metadata, a sustainability score for each vehicle to serve the data cache demand is determined. One or more vehicles from the plurality of vehicles is selected based on the sustainability score for each vehicle and the sustainability metric for the at least one subregion. The selected one or more vehicles is routed to the at least one subregion. Data is served from the selected one or more vehicles to meet the cache demand within the at least one subregion.

### BACKGROUND

Embodiments of the present disclosure relate to dynamic placement of vehicle within a geographic region.

### BRIEF SUMMARY

According to embodiments of the present disclosure, methods for dynamic placement of vehicles within a geographic region are provided. Metadata of a plurality of vehicles in the geographic region is read. Data cache demand and a sustainability metric for at least one subregion of the geographic region is read. Based on the metadata, a sustainability score for each vehicle to serve the data cache demand is determined. One or more vehicles from the plurality of vehicles is selected based on the sustainability score for each vehicle and the sustainability metric for the at least one subregion. The selected one or more vehicles is routed to the at least one subregion. Data is served from the selected one or more vehicles to meet the cache demand within the at least one subregion.

Each of the plurality of vehicles may be autonomous. Each of the plurality of vehicles may be interconnected via a wireless network. The geographic region may be a city. The metadata may comprise carbon emission metrics for each vehicle. The carbon emission metrics may be based on a processing efficiency of an edge server of the vehicle and an operational efficiency of the vehicle. The processing efficiency of the edge server may comprise an amount of carbon dioxide emitted per data unit stored and an amount of carbon dioxide emitted per data unit processed. The operational efficiency may comprise an amount of carbon dioxide emitted per distance traveled and an amount of carbon dioxide emitted per energy unit consumed. The sustainability score may comprise a carbon emission amount and the sustainability metric may comprise a carbon emission limit. A charging location may be identified for each vehicle. A parking location may be identified within the at least one subregion for each vehicle. A distance between the charging location and the parking location may be determined. An energy requirement for each vehicle based on a distance from a first location to a second location for each vehicle may be determined. The first location may be a current location of the vehicle and the second location may be a location within the at least one subregion. The first location may be a charging availability location within the at least one region and the second location may be a parking location within the at least one region. An energy requirement for each vehicle based on data cache demand for the at least one subregion may be determined. An energy requirement and an energy capacity for each autonomous vehicle may be compared.

According to embodiments of the present disclosure, systems for dynamic placement of vehicles within a geographic region are provided. A system comprising a computing node is provided. The computing node comprises a computer readable storage medium having program instructions embodied therewith. The program instructions executable by a processor of the computing node to cause the processor to perform a method for dynamic placement of vehicles within a geographic region as disclosed herein.

### BRIEF DESCRIPTION OF THE SEVERAL VIEWS OF THE DRAWINGS

FIG. 1 is a flow diagram illustrating a framework for dynamic placement of vehicles within a geographic region, in accordance with one or more embodiments of this disclosure.

FIG. 2 is an illustration of regions of a city, in accordance with one or more embodiments of this disclosure.

FIG. 3 is an illustration of charging availability within regions of a city, in accordance with one or more embodiments of this disclosure.

FIG. 4 is an illustration of carbon metrics gathered from vehicles, in accordance with one or more embodiments of this disclosure.

FIG. 5 is a flowchart illustrating a method for dynamic placement of vehicles, in accordance with one or more embodiments of this disclosure.

FIG. 6 depicts a computing node according to an embodiment of the present disclosure.

FIG. 7 depicts a computing environment for the execution of at least some of the computer code involved in performing a method for dynamic placement of vehicles, in accordance with one or more embodiments of this disclosure.

### DETAILED DESCRIPTION

Smart city infrastructure facilitates the movement of autonomous vehicles both within and outside the city, enhancing public transportation efficiency. An intelligent transport system can dynamically manage the flow of autonomous vehicles based on the varying public transport requirements in different regions of the city.

An autonomous vehicle (e.g., autonomous car) is a mode of transportation incorporating driving automation (e.g., vehicular automation), that is, a ground vehicle capable of sensing its environment and moving safely with little or no human input. Self-driving cars combine a variety of sensors to perceive their surroundings, such as thermographic cameras, radar, lidar, sonar, GPS, odometry and inertial measurement units. Advanced control systems interpret sensory information to identify appropriate navigation paths, as well as obstacles and relevant signage. Control methods based on Artificial Intelligence can then be used to learn all the gathered sensory information in order to control the vehicle and support various autonomous-driving tasks.

Autonomous vehicles bring a new ecosystem to public transportation, characterized by significant data generation and simultaneous consumption of that data. This ecosystem encompasses multiple communication streams, including: (1) data communication among vehicles or with traffic management to ensure safe driving; (2) data communication among vehicle occupants and the outside world; (3) internal data communication within the vehicle to facilitate optimal decision-making; and (4) data communication to cloud and edge data servers for data retention, enabling safety analysis, future predictions, incident decoding, etc. Consequently, there is a significant flow of data among vehicles, edge node server, and the cloud. This interconnectedness requires autonomous vehicles to be equipped with considerable computational resources, such as CPUs, storage, and network capabilities, to perform the complex tasks necessary for safely transporting passengers from one location to another.

A variety of methods and systems are known for using available computational resources (e.g., CPUs, storage, and network capabilities) on autonomous vehicles as mobile edge data centers. This can be particularly relevant given the challenges associated with the installation of edge computing servers in multiple locations through the smart city, which is often impractical. Such conventional methods and systems generally have been considered satisfactory for their intended purpose. However, such conventional methods and systems often underutilize the computational resources on autonomous vehicles for runtime analysis, particularly in scenarios involving parked vehicles or vehicles traveling on straight, empty roads, where resource consumption remains low. In these scenarios, on-board resources such as those associated with evaluating vehicle turning angles and conducting congestion analysis can run on minimal resource consumption, making them available for data caching services. In addition to the underutilization of on-board resources, conventional methods and systems do not take into account sustainability metrics (e.g., carbon emission threshold limit) of the local region. In addition, conventional methods and systems do not take into account the charging source capability of an autonomous vehicle. As such, there is a need for the dynamic placement of edge node enabled autonomous vehicles based on data caching demand within a smart city, the sustainability score of autonomous vehicles, and sustainability threshold of smart city regions.

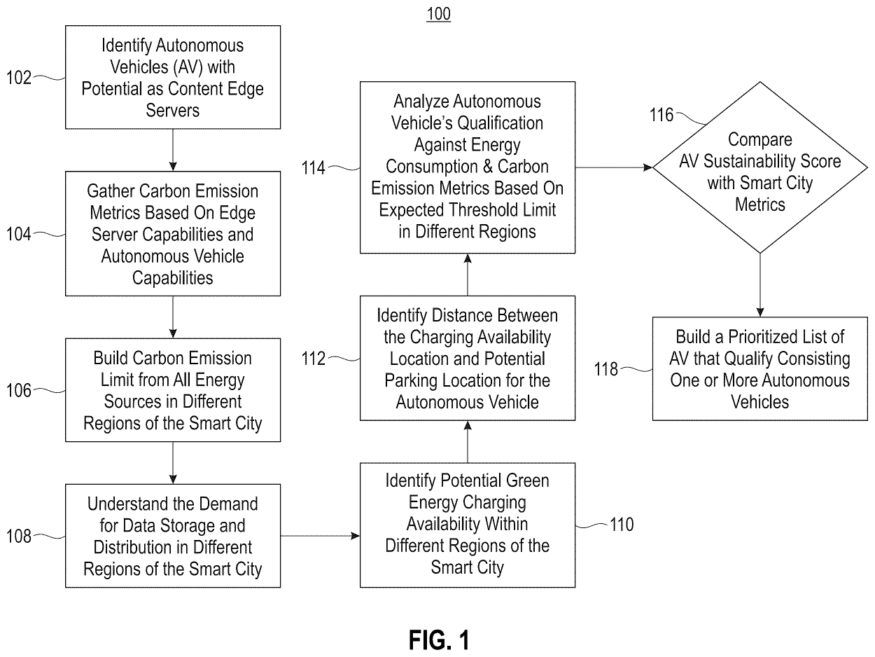

FIG. 1 is a flow diagram illustrating a framework for dynamic placement of vehicles within a geographic region, in accordance with one or more embodiments of this disclosure. Vehicles may be autonomous vehicles and/or manually operated vehicles. Vehicles may be interconnected via a wireless network. At 102, vehicles (e.g., autonomous vehicles) that can serve as content edge servers are identified (e.g., by a network). At 104, carbon emission metrics are gathered (for each identified vehicle). Carbon emission metrics may be based on the edge server capabilities of the vehicle and capabilities of the vehicle itself. At 106, a carbon emission limit is built for one or more regions in the geographic region (e.g., smart city) based on all energy sources within the region. At 108, the demand for data storage and distribution in the one more regions is determined. At 110, available green energy charging locations within the one or more regions is identified by the network. A parking location for the vehicle may also be identified. At 112, the distance between an available charging location and a parking location for a vehicle is identified. At 114, a vehicle's qualification to serve data to a region is analyzed using the vehicle's carbon emission metrics, energy consumption to serve data to a region, and the expected threshold carbon emission limit of a region. At 116, a vehicle's sustainability score is compared to a region's sustainability metric. The sustainability score can be determined using the vehicle's carbon emission metrics. The sustainability score of vehicles can include one or more of: the amount of carbon emissions associated with data caching processes, carbon emissions of the vehicle (e.g., carbon emissions from routing the vehicle to a region), energy consumption associated with data caching processes, and energy consumption of the vehicle (e.g., energy consumption from routing the vehicle to a region). The sustainability metric of a region can include a carbon emission threshold limit of the region and/or an energy consumption limit. At 118, a prioritized list of vehicles that qualify to serve the data to a region is built. The prioritized list of vehicles may include on or more vehicles. The one or more vehicles of the prioritized list may be routed to a region to serve the data to that region. In this way, the one or more vehicles are used to meet the region's demand for data storage and distribution. The routing of vehicles (e.g., an autonomous vehicle, manually operated vehicle) to different regions in a geographic region (e.g., a city) with data demands can be based on multiple factors including: 1) the sustainability metrics of the region; 2) the sustainability score of vehicles; 3) the energy requirement to cache data based on the current and/or projected demand; 4) the energy requirement to serve as a content edge server for a certain period of time based on a projected duration and/or the availability of the vehicle; 5) the energy requirement to re-charge the vehicle after energy consumption (e.g., energy consumption from data caching); 6) the energy source available (e.g., Green Energy source) in different regions; 7) the energy requirement to move the vehicle if it is not already present in the region. One or more vehicles may be qualified to serve the data to a region. The demand for data storage and distribution in different regions of the smart city can be determined via CDN service providers and data providers.

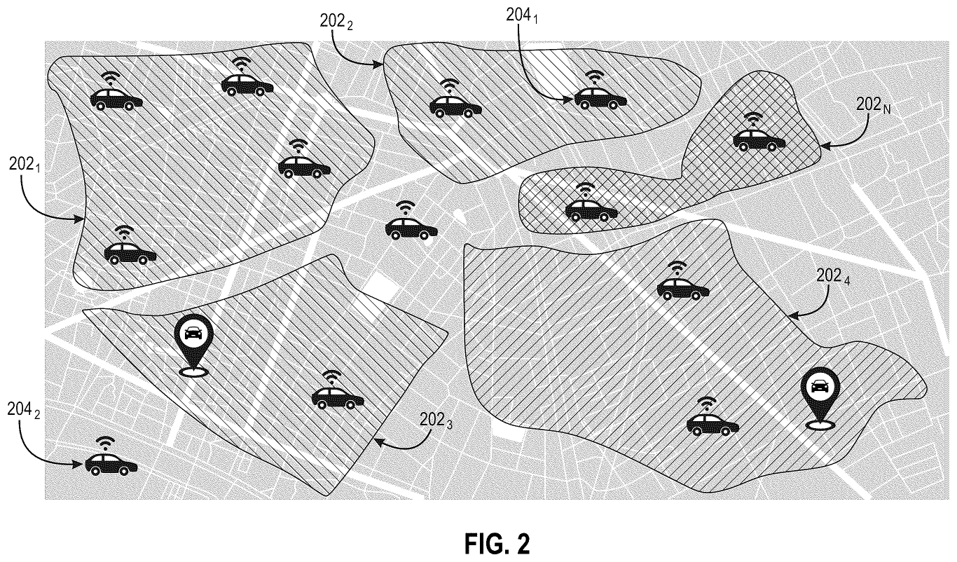

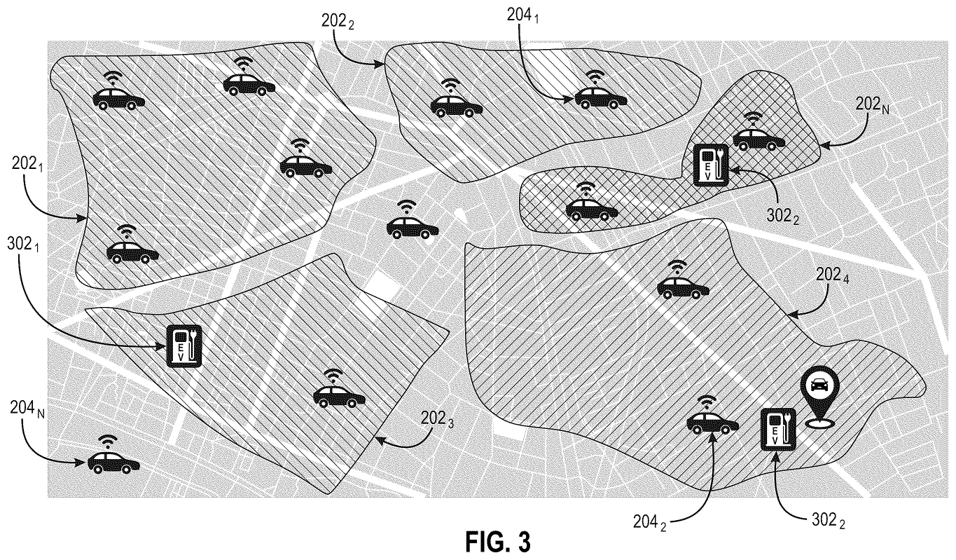

FIG. 2 is an illustration of regions 202 (alternatively, subregions) of a geographic region 200 (e.g., a smart city), in accordance with one or more embodiments of this disclosure. A region 202 is a geographical area situated within the geographical region 200. A smart city may have multiple regions 202 (e.g., region 2021, region 2022, region 2023, region 2024, and region 202N hereinafter collective referred to as regions 202) based on the population, energy source available (e.g., fossil fuels, renewable energy resources), and carbon emission threshold limit. Regions 202 may be arranged in various configurations with respect to one another. For example, and without limitation, regions 202 may be separated by an intervening space or gap, for example as illustrated in FIGS. 2 and 3. One or more vehicles 204 (vehicle 2041 and vehicle 204N, hereinafter collectively referred to as vehicles 204) may be located within a region 202 and may either be parked (e.g., parked and charging at a charging location) or moving. One or more vehicles 204 may be parked or moving outside of the regions 202. As used herein, N represents a positive integer, and accordingly the number of scenarios implemented in a given embodiment of the present invention is not limited to those depicted in FIG. 2.

FIG. 3 is an illustration of charging availability within regions 202 of geographic region 200 (e.g., a smart city), in accordance with one or more embodiments of this disclosure. Charging availability, in particular for Green Energy, may vary across different regions within the smart city. One or more charging locations 302 (e.g., charging location 3021, charging location 3022, and charging location 302N, hereinafter collectively referred to as charging locations 302) may be located within one or more regions 202, while one or more regions may not include a charging location 302. One or more vehicles 204 may be routed to a charging location 302 in a region 202. For example, in the depicted embodiment, vehicle 2042 in region 2024 is directed to charging location 3022. The one or more vehicles 204 selected to serve data and meet the cache demand within a region 202 can be selected based on the charging availability (e.g., available electric vehicle charging locations) within the region 202. As used herein, N represents a positive integer, and accordingly the number of scenarios implemented in a given embodiment of the present invention is not limited to those depicted in FIG. 3.

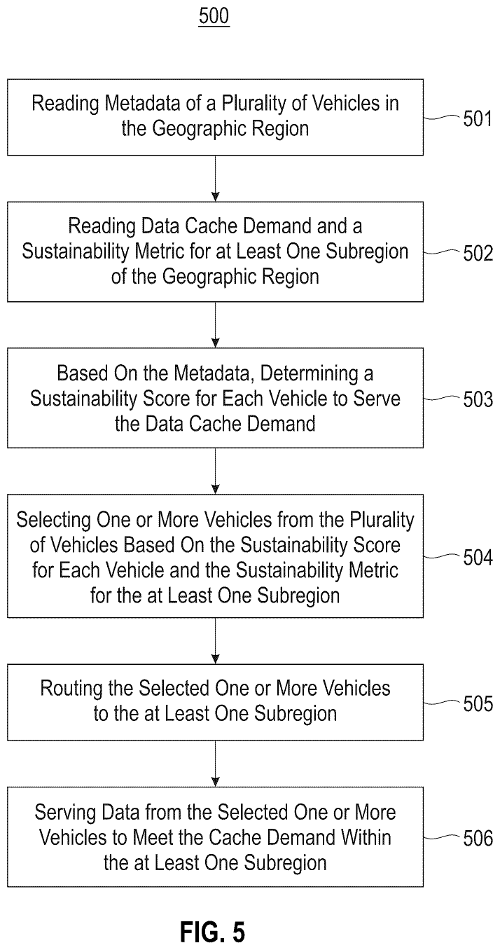

FIG. 5 is a flowchart illustrating an exemplary method 500 for dynamic placement of vehicles in a smart city. The operations of method 500 presented below are intended to be illustrative. In some implementations, method 500 may be accomplished with one or more additional operation not described and/or without one or more of the operations discussed. Additionally, the order in which the operations of method 500 are illustrated in FIG. 5 and described below is not intended to be limiting.

In some implementations, method 500 may be implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 500.

Operation 501 may include reading metadata of a plurality of vehicles in the geographic region. The autonomous vehicles may be edge node enabled autonomous vehicles. Operation 502 may include reading data cache demand and a sustainability metric for at least one subregion of the geographic region. The sustainability metric can be a carbon emission limit and/or an energy consumption limit of the region. The carbon emission limit may be a threshold of carbon emission (e.g., an amount of carbon dioxide) that a region can produce. The energy consumption limit may be a threshold of energy that can be consumed in a region.

Operation 503 may include determining a sustainability score (e.g., carbon emission amount and/or energy consumption amount to serve the data cache demand) for each vehicle to serve the data cache demand. Data cache demand can include current and projected demand for data caching in a region of the smart city. Data cache demand for the region can be based on the frequency and volume of data access requests along with the associated data processing (e.g., data retrieval, data storage, and data transfer) within a geographical area or network segment. The carbon emission amount for each vehicle may be an amount of a gas (e.g., carbon dioxide).

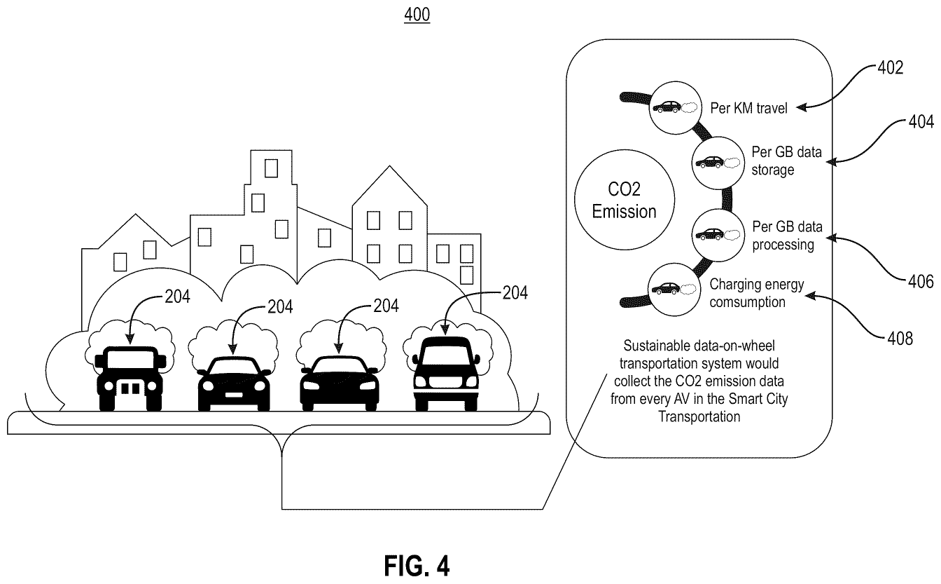

The carbon emission amount may be determined using the carbon metrics of a vehicle. FIG. 4 is an illustration of exemplary carbon metrics of vehicles. Carbon metrics of a vehicle can include an amount of carbon dioxide emission per kilometer traveled 402, per gigabyte of data storage 404, and/or per gigabyte data processing 406. Carbon metrics of a vehicle can include an amount of carbon dioxide emission due to charging energy consumption 408. In some implementations, the method may further include reading one or more carbon emission metrics for each vehicle in a geographic region 200. The one or more carbon emission metrics may be based on the processing efficiency of the edge server of a vehicle. In some implementations, the carbon emission metrics based on the processing efficiency of the edge server of a vehicle includes an amount of carbon dioxide emitted per data unit stored (e.g., per gigabyte data storage as shown in FIG. 4) 404 and/or an amount of carbon dioxide emitted per data unit processed (e.g., per gigabyte data processed as shown in FIG. 4) 406. Alternatively or additionally, the one or more carbon emission metrics may be based on the operational efficiency of the vehicle. In some implementations, the carbon emission metrics based on the operational efficiency of a vehicle includes an amount of carbon dioxide emitted per distance traveled (e.g., per kilometer travelled as shown in FIG. 4) 402 and/or an amount of carbon dioxide emitted per energy unit consumed, which can be charging energy consumption 408, as shown in FIG. 4. The carbon metrics of a vehicle may be used to determine the carbon emission to cache data on a vehicle and the carbon emission to deliver the data to an end receiver (e.g., multiple IoT, sensors, devices). In some implementations, other sources of carbon emission in addition or alternatively to those described may be considered to determine a carbon emission amount for each autonomous vehicle.

In some implementations, the method includes determining an energy requirement (i.e., an amount of energy required) for a vehicle to perform one or more operations associated with data caching, data distribution, and routing of the autonomous vehicle to a region. The method may include determining the energy capacity (e.g., an amount of energy currently available, maximum energy capacity) of a vehicle. The energy requirement may include an amount of energy required to: cache data on a vehicle based on the current and projected data demand; deliver the data to an end receiver; and re-charge the vehicle (e.g., green energy requirement) based on the energy source available in the target region.

The method may include identifying a first location and a second location. In some implementations, the first location is a current location of a vehicle, and the second location is a location within the target region. In some implementations, the first location is a charging location (e.g., within the target region, a region proximal to the target region, a region proximal to the autonomous vehicle) and the second location is a parking location within the at least one region. The method may further include determining a travelling distance between the first and second location. The energy requirement may be based on the travelling distance from the first location to the second location.

Operation 504 may include selecting one or more vehicles from the plurality of vehicles based on the sustainability score for each vehicle and the sustainability metric for the at least one subregion. Operation 505 may include routing the selected one or more vehicles to the at least one subregion. The one or more vehicles selected may be routed to a location (e.g., charging location, parking location) within a region. Routing the one or more autonomous vehicles to a location within a region can include transmitting a signal from a system or edge server to the one or more vehicles, providing the vehicle with routing instructions. In some implementations, autonomous vehicles can collaborate to enhance data caching processes through vehicle platooning. For example, a vehicle can assist another vehicle by data caching for the assisted vehicle.

Operation 506 may include serving data from the selected one or more vehicles to meet the cache demand within the at least one subregion. Selecting the one or more vehicles from the plurality of vehicles may be based on the carbon emission amount for each vehicle and the carbon emission limit for the at least one region. Additionally or alternately, selecting the one or more vehicles from the plurality of vehicles based on the energy requirement and the energy capacity of each vehicle. The carbon emission amount of the one or more vehicles selected may be less than or about the carbon emission limit of the at least one region. The energy capacity (e.g., amount of energy currently available, maximum energy capacity) of the one or more vehicles selected may be greater than or about the energy requirement. The one or more vehicles may function as edge servers within a region.

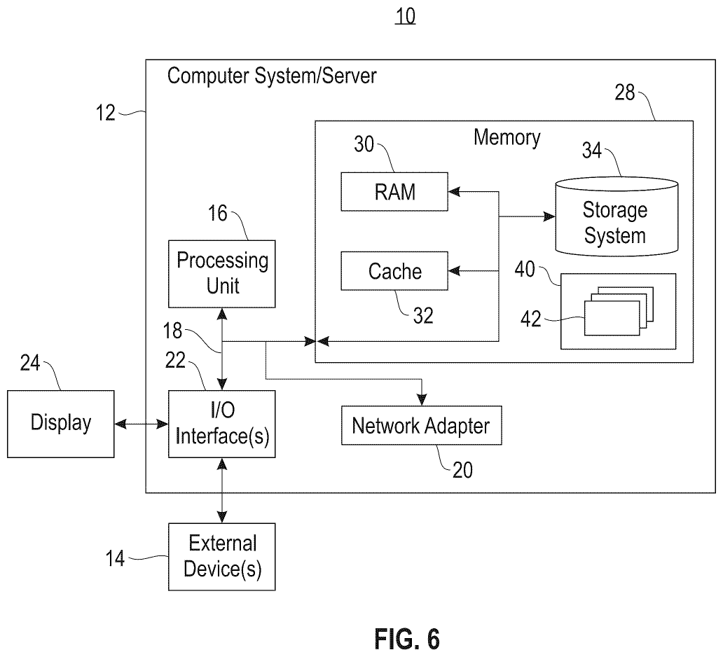

Referring now to FIG. 6, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any

suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

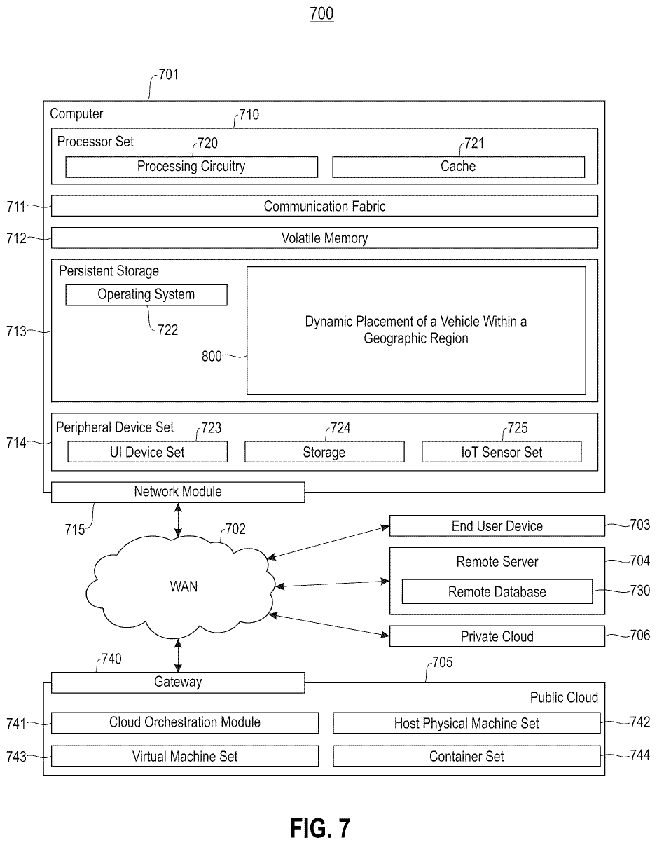

Referring now to FIG. 7, computing environment 700 contains an example of an environment for the execution of at least some of the computer code involved in performing the inventive methods, such as dynamic placement of a vehicle within a geographic region 800. In addition to block 800, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 800, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer-readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 800 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 800 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer-readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference has been made in detail herein to the exemplary embodiments of the present disclosure, examples of which are illustrated in the accompanying drawings. The systems, devices, and methods disclosed herein are described in detail by way of examples, and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

For any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

As used herein, the term “about” means a range of values inclusive of the specified value that a person of ordinally skill in the art would reasonably consider to be comparable to the specified value. In some embodiments, “about” means within a standard deviation using measurements generally accepted by a person of ordinary skill in the art. In some embodiments, “about” means ranging up to ±10% of the value. In some embodiments, “about” means ranging up to ±5% of the value. In some embodiments, “about” means the specified value.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for dynamic placement of vehicles within a geographic region, the method comprising:
reading metadata of a plurality of vehicles in the geographic region;
reading data cache demand and a sustainability metric for at least one subregion of the geographic region;
based on the metadata, determining a sustainability score for each vehicle to serve the data cache demand;
selecting one or more vehicles from the plurality of vehicles based on the sustainability score for each vehicle and the sustainability metric for the at least one subregion;
routing the selected one or more vehicles to the at least one subregion; and
serving data from the selected one or more vehicles to meet the cache demand within the at least one subregion.

2. The method of claim 1, wherein each of the plurality of vehicles is autonomous.

3. The method of claim 1, wherein each of the plurality of vehicles is interconnected via a wireless network.

4. The method of claim 1, wherein the geographic region is a city.

5. The method of claim 1, wherein the metadata comprises carbon emission metrics for each vehicle.

6. The method of claim 5, wherein the carbon emission metrics are based on a processing efficiency of an edge server of the vehicle and an operational efficiency of the vehicle.

7. The method of claim 6, wherein the processing efficiency of the edge server comprises an amount of carbon dioxide emitted per data unit stored and an amount of carbon dioxide emitted per data unit processed.

8. The method of claim 6, wherein the operational efficiency comprises an amount of carbon dioxide emitted per distance traveled and an amount of carbon dioxide emitted per energy unit consumed.

9. The method of claim 1, wherein the sustainability score comprises a carbon emission amount and the sustainability metric comprises a carbon emission limit.

10. The method of claim 1, further comprising:
identifying a charging location for each vehicle;
identifying a parking location within the at least one subregion for each vehicle; and
determining a distance between the charging location and the parking location.

11. The method of claim 1, further comprising:
determining an energy requirement for each vehicle based on a distance from a first location to a second location for each vehicle.

12. The method of claim 11, wherein the first location is a current location of the vehicle and the second location is a location within the at least one subregion.

13. The method of claim 11, wherein the first location is a charging availability location within the at least one region and the second location is a parking location within the at least one region.

14. The method of claim 1, further comprising:
determining an energy requirement for each vehicle based on data cache demand for the at least one subregion.

15. The method of claim 1, further comprising:
comparing an energy requirement and an energy capacity for each autonomous vehicle.

16. A system comprising:
a computing node comprising a computer readable storage medium having program instructions embodied therewith, the program instructions executable by a processor of the computing node to cause the processor to perform a method comprising:
reading metadata of a plurality of vehicles in the geographic region;
reading data cache demand and a sustainability metric for at least one subregion of the geographic region;
based on the metadata, determining a sustainability score for each vehicle to serve the data cache demand;
selecting one or more vehicles from the plurality of vehicles based on the sustainability score for each vehicle and the sustainability metric for the at least one subregion;
routing the selected one or more vehicles to the at least one subregion; and
serving data from the selected one or more vehicles to meet the cache demand within the at least one subregion.
